(19) United States
(12) Patent Application Publication
(10) Pub. No.: US 2006/0256465 A1
(43) Pub. Date: Nov. 16, 2006

(54) Tape system with dynamically controlled flangeless rollers

(76) Inventor: Robert Glenn Biskeborn, Hollister, CA (US)

Correspondence Address: INTERNATIONAL BUSINESS MACHINES CORPORATION, 650 Harry Road, L2PA/J2C, INTELLECTUAL PROPERTY LAW, SAN JOSE, CA, 95120-6099, US

(21) Appl. No.: 11/128,066

(22) Filed: May 11, 2005

(51) Int. Cl. G11B 15/18

(52) U.S. Cl. 360/71

(57) ABSTRACT

A tape recording system is provided comprising slightly convex, or barrel-shaped, flangeless roller guides mounted on actuators to control the transverse position of the tape. Self-centering of the tape on the convex roller guide surface allows the tape to follow actuator driven movement of the roller guides to correct for tape displacement. Surface texture on the roller guide surface promotes tack-down of the tape on the roller guide surface further improving tape response to actuator driven movement of the roller guides to correct tape displacement. A method for correcting transverse displacements of a tape in accordance with the invention is disclosed.

### BACKGROUND OF THE INVENTION

1. Field of the Invention

The invention relates to the field of recording tape transport mechanisms and more particularly to a tape recording system having actuator controlled flangeless rollers to control the transverse position of the tape.

2. Description of the Related Art

Magnetic tape storage systems are widely used in computer systems for storing and retrieving large amounts of data. Current systems typically read and write from parallel tracks on the tape which vary in number based on the design of the system. Each track of the head has a read and a write magnetic transducer (head) arranged in tandem so that the data written by the write head can be verified by the read head. The head pairs may be alternated so that one set of the tracks are written and read when the tape travels in one direction and the other set is used when the tape is moving in the opposite direction.

Some tapes are written with magnetic servo information thereon to allow positioning of the heads in relation to the tracks. All tapes have a magnetic noise floor which is present even when the tape is erased. Therefore, even a tape with no data recorded thereon will generate a noise signal in the read heads and tapes with servo information will also generate signals corresponding to servo information.

For high density recording the tape must be precisely positioned and tensioned as it moves across the head assembly. The tape is typically supported and positioned by support surfaces, for example cylindrical rollers or posts or guides disposed on each side of the head. The support surfaces are positioned to form the wrap angles which are the angles of the plane of the tape with respect to the air bearing surfaces of the head. Precise wrap angles are necessary for optimum performance.

Therefore, there is an ongoing need for improved tape support and positioning systems to reduce damage to the recording tape and to provide precise stability and tracking of the tape relative to the recording head during operation.

### SUMMARY OF THE INVENTION

In accordance with the principles of the present invention, there is disclosed a tape recorder drive system comprising a head assembly, at least one roller guide adjacent to the head assembly having a substantially cylindrical surface with a slightly convex shape supporting a tape moving across the head assembly, sensor means for detecting a transverse displacement of the tape, and an actuator supporting the roller guide to move the roller guide axially in a opposite direction to the transverse displacement of the tape. The grooved or otherwise textured, slightly convex, or barrel-shaped, flangeless rollers mounted on actuators control the transverse position of the tape. Self-centering of the tape on the convex roller guide surface allows the tape to follow actuator driven movement of the roller guides to correct for tape displacement. Surface texture on the roller guide surface promotes tack-down of the tape on the roller guide surface further improving tape response to actuator driven movement of the roller guides to correct tape displacement.

A method of correcting transverse displacements of a tape passing over a head assembly is disclosed comprising providing a roller having a convex surface and/or surface texture to allow the tape to follow axial movements of the roller guide, sensing a displacement of the tape transverse to the direction of longitudinal tape motion across the head assembly, moving the roller guide in an opposite direction to the transverse tape displacement in response to a signal from the sensor to an actuator, moving the tape with the roller guide in the direction opposite to the detected tape displacement, and sensing correction of the tape displacement ending actuator driven movement of the roller guide.

The above, as well as additional objects, features and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings. In the following drawings, like reference numerals designate like or similar parts throughout the drawings:

FIG. 1. is a simplified diagram of a magnetic tape recorder system using the dynamically controlled flangeless rollers of the present invention;

FIG. 2 is a plan view, not to scale, of an embodiment of a tape drive incorporating the present invention;

FIG. 3 is a side view, not to scale, of the roller guides and head assembly portion of the tape drive of FIG. 2;

FIG. 4 is a flow chart of a method of correcting transverse displacements of a tape according to the present invention.

### DETAILED DESCRIPTION OF THE PREFERRED EMBODIMENT

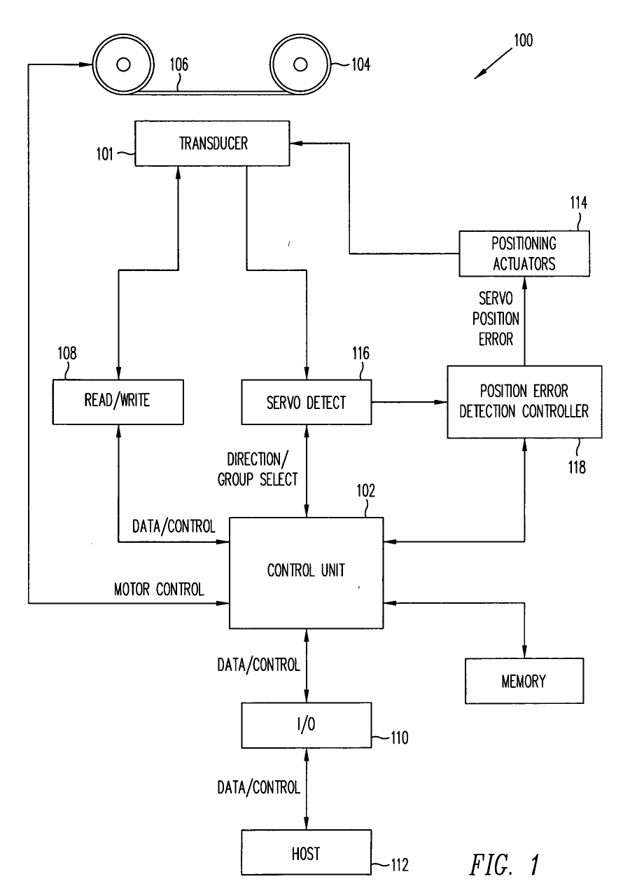

FIG. 1 illustrates an embodiment of a magnetic tape recorder or tape drive system 100 incorporating the dynamically controlled flangeless rollers of the present invention. A tape drive control unit 102 provides a motor control signal to rotate tape reels 104 and move magnetic tape 106 across the read/write transducer head 101. Read/write channel 108 transmits read/write signals between the read/write transducer 101 and the control unit 102. The data is communicated through I/O channel 110 with host 112. Lateral positioning of the transducer 101 with respect to the tape 106 is accomplished by coarse and fine positioning actuators 1114. The lateral repositioning by a coarse actuator is required to access the various tracks of the tape 106 with the transducer 101. A servo system and fine actuator may be employed for accessing various tracks and for accurate lateral repositioning of the transducer 102. An exemplary servo system includes a servo detector 116 to detect both the track that the head is currently on and whether the head is off center. Control unit 102 indicates the track address of a desired new track to position error detection controller 118 for repositioning the head. Servo detector 116 indicates the current track to position error detection controller 118, and the controller provides a servo position error signal to the coarse actuator of positioning actuators 114 which repositions the transducer 101 to the new track. The servo system also provides track following signals to the fine actuator of positioning actuators 104 so that the tracks on tape 106 may be closely spaced.

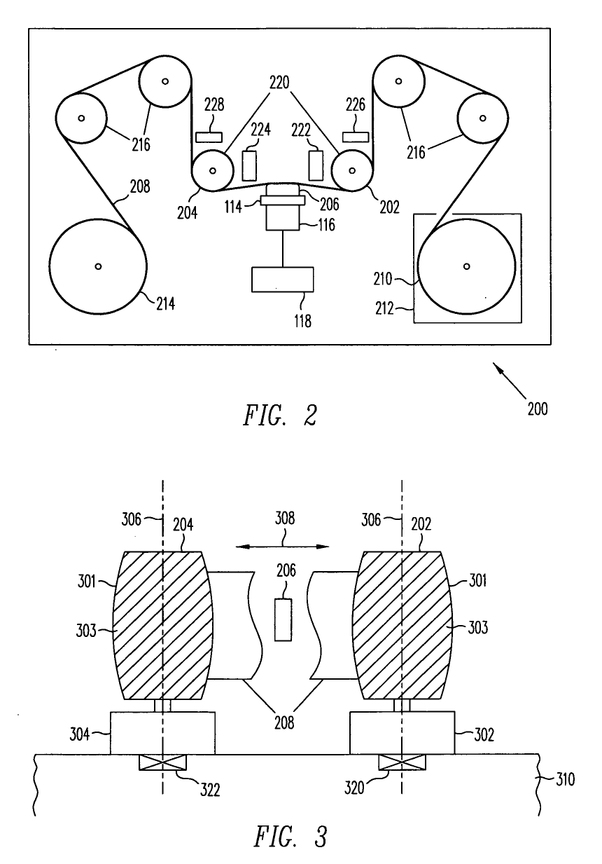

FIG. 2 illustrates an embodiment of a tape drive system 200 using dynamically controlled flangeless rollers mounted on actuators to control the transverse position of the tape. First and second tape roller guides 202 and 204 are disposed on each side of a head assembly 206. A recording tape 208 is guided in a path from a supply reel 210 contained in a tape cassette 212 to a take-up reel 214 by a series of rollers or pins 216 and roller guides 202 and 204 that control the position of the tape as it passes over the head assembly 206. The tape 208 engages the surfaces of the roller guides 202 and 204 which control the wrap angle and transverse position of the tape passing over the head assembly 206.

The tape roller guides 202 and 204 have generally cylindrical shape, preferably having a slightly convex, or barrel shape with grooved or textured surfaces 220 to promote tape-guide interaction that enables control by the roller guides 202 and 204 of tape position transverse to the direction of longitudinal tape motion across the head assembly 206. The textured surfaces 220 may comprise groove patterns that assist the tape in tacking down and not slipping relative to the roller guide surface, or alternatively, a thin coating of polyurethane or other compliant material that increases sliding friction while limiting drag and power dissipation. The preferably slightly convex, or barrel shape of the generally cylindrical roller guides provides an advantage due to the tendency for the transverse dimension of the tape 208 to remain centered over the maximum radius portion of the roller guides 202 and 204 in response to the action of transverse forces on the tape moving longitudinally over the convex surface. Sensors 222 and 224 preferably positioned between the head assembly 206 and roller guides 202 and 244, respectively, sense the transverse position of the tape 208. Alternatively, additional sensors 226 and 228 may be may be used for dynamic skew detection and control. Having multiple sensors disposed one on each side of each actuated roller guide 202 and 204 provides sensitive detection of dynamic skew.

FIG. 3 shows a side view of the roller guide and head assembly portion of the tape drive system 200. The generally cylindrical shaped roller guides 202 and 204 are preferably flangeless with a slightly convex shaped surface 301 along the axial direction of the rollers. As described herein above the convex surface 301 provides a centering tendency of the tape 208 over the maximum radius portion of the roller surface. This self-centering action of the tape eliminates the need for upper and lower flanges on the rollers to prevent excessive tape wander in the axial direction. Elimination of flanges has the benefit of eliminating damage at the tape edges due to interaction with the flanges. The convex surface 301 preferably has a texture 303 in the form of groove patterns to assist the tape to tack down on the surface. The roller guides 202 and 204 are supported by bearings 320 and 322, respectively, mounted on a base 310. Additional bearings (not shown) mounted on a cover plate (not shown) may also be used to provide additional support of the roller guides. Linear actuators 302 and 304 mounted on the base 310 are configured to move the roller guides in a direction parallel to the cylindrical axes 306 of the roller guides and perpendicular to the direction of longitudinal tape motion across the head assembly indicated by the double-headed arrow 308 depicting either forward or backward motion of the tape. Magnetic actuators such as voice coil actuators may be used for this purpose. Sensors 222 and 224 positioned one on each side of the head assembly 206 sense the transverse position of the tape 208 and provide signals to servo electronics (not shown) to control actuator positioning of the roller guides 202 and 204 in response to transverse displacement of the tape 208. Detection of a transverse displacement of the tape by a sensor 222 or 224 results in a control signal to associated actuator 302 or 304 causing the roller guide 202 or 204 to move axially in the direction opposite to the direction of tape displacement. The tape follows this corrective movement of the roller guide to the desired transverse alignment with respect to the head assembly. Various sensor means may be used to detect transient displacements of the tape such as providing strain gauge detectors in the actuator, or alternatively, by direct detection of the tape position by optical or magnetic means. Actuator and sensor means having suitable sensitivity and frequency response are known to those skilled in the art.

The convex shaped surface and/or the surface texture provide advantages to correction of transverse tape movement since, first, the tape will tend to self-correct by recentering on the convex surface 301, and second, when the roller guide is moved by the actuator in response to sensor detection of the transverse tape movement, the surface texture improves the ability of the tape to follow roller guide movements in the axial direction due to the tack-down effect of the texture. These features of the present invention significantly improve the actuator driven corrections of the tape transverse position.

Alternatively, the roller guides 202 and 204 may comprise cylinders having textured or coated surfaces parallel to the cylinder axes. The self-centering effect on the tape of the slightly convex roller guide surfaces will be lost, however, the coated or textured surfaces alone provide sufficient frictional force on the tape to cause the tape to follow axial movement of the roller guides to correct transverse displacements of the tape.

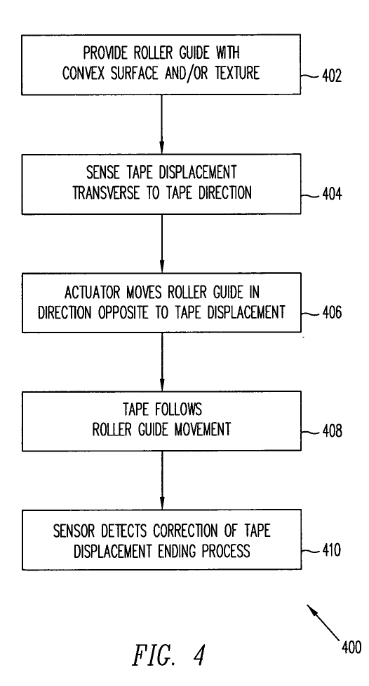

FIG. 4 is a flow chart of a method 400 of correcting transverse displacements of the tape 208 according to the present invention. With reference to FIGS. 2 and 3, in step 402, roller guides 202 and 204 are provided having a convex surface 301 and/or surface texture 303 to allow the tape to follow axial movements of the roller guides. In step 404, sensors 222 and 224 detect a displacement of the tape transverse to the direction of longitudinal tape motion across the head assembly. In step 406, actuators 302 and 304 move the roller guides 202 and 204, respectively, in an opposite direction to the direction of the transverse tape displacement in response to signals from sensors 222 and 224. In step 408, the tape moves with the roller guides in the direction opposite to the detected tape displacement. In step 410, the sensors 222 and 224 detect correction of the tape displacement ending actuator driven movement of the roller guides 202 and 204.

While the present invention has been particularly shown and described with reference to the preferred embodiments, it will be understood by those skilled in the art that various changes in form and detail may be made without departing from the spirit, scope and teaching of the invention. Accordingly, the disclosed invention is to be considered merely as illustrative and limited only as specified in the appended claims.

I claim:

1. A tape recorder system, comprising:
a head assembly;
at least one roller guide disposed adjacent to the head assembly, said roller guide having a substantially cylindrical surface with a slightly convex shape supporting a tape moving across the head assembly;
sensor means for detecting a transverse displacement of the tape; and
an actuator supporting the at least one roller guide, wherein said actuator moves the roller guide axially in an opposite direction to the transverse displacement of the tape.

2. The tape recorder system of claim 1, wherein the cylindrical surface of the roller guide has a texture of groove patterns.

3. The tape recorder system of claim 1, wherein the cylindrical surface of the roller guide is coated with a compliant material.

4. A tape recorder system, comprising:
a head assembly;
at least one roller guide disposed adjacent to the head assembly, said roller guide having a cylindrical surface with a texture of groove patterns supporting a tape moving across the head assembly;
sensor means for detecting a transverse displacement of the tape; and
an actuator supporting the at least one roller guide, wherein said actuator moves the roller guide axially in an opposite direction to the transverse displacement of the tape.

5. A tape recorder system, comprising:
a head assembly;
first and second of roller guides disposed one on each side of the head assembly, said roller guides having a substantially cylindrical surface with a slightly convex shape supporting a tape moving across the head assembly;
sensor means for detecting a transverse displacement of the tape;
a first actuator supporting the first roller guide, wherein said first actuator moves the first roller guide axially in an opposite direction to the transverse displacement of the tape; and
a second actuator supporting the second roller guide, wherein said second actuator moves the second roller guide axially in an opposite direction to the transverse displacement of the tape.

6. The tape recorder system of claim 5, wherein the cylindrical surfaces of the first and second roller guides have a texture of groove patterns.

7. The tape recorder system of claim 5, wherein the cylindrical surface of the first and second roller guides are coated with a compliant material.

8. A method of correcting transverse displacements of a tape passing over a head assembly, the method comprising:
providing a roller having a convex surface and/or surface texture to allow the tape to follow axial movements of the roller guide;
sensing a displacement of the tape transverse to the direction of longitudinal tape motion across the head assembly;
moving the roller guide in an opposite direction to the direction of the transverse tape displacement in response to a signal from the sensor to an actuator;
moving the tape with the roller guide in the direction opposite to the detected tape displacement; and
sensing correction of the tape displacement ending actuator driven movement of the roller guide.
